(19) United States
(12) Patent Application Publication
(10) Pub. No.: US 2024/0100769 A1
(43) Pub. Date: Mar. 28, 2024

(54) METHOD FOR MANUFACTURING STEREOLITHOGRAPHICALLY FABRICATED OBJECT

(71) Applicant: FUJIKURA LTD., Tokyo (JP)

(72) Inventors: Hiroyuki Kusaka, Tokyo (JP); Masahiro Kashiwagi, Tokyo (JP)

(73) Assignee: FUJIKURA LTD., Tokyo (JP)

(21) Appl. No.: 18/273,606

(22) PCT Filed: Nov. 9, 2021
(86) PCT No.: PCT/JP2021/041097

§ 371 Date: Jul. 21, 2023

(30) Foreign Application Priority Data
Feb. 18, 2021 (JP) 2021-024500

(51) Int. Cl. B29C 64/129; B29C 64/268

(52) U.S. Cl. CPC B29C 64/129; B29C 64/268; B33Y 10/00

(57) ABSTRACT

A method for manufacturing a stereolithographically fabricated object includes separately irradiating, with light, respective n regions R₁ to Rₙ of a photo-curable resin, where n is an integer of not less than 2. An overlap area of the region Rᵢ overlaps a part of the region Rⱼ, where i is an integer that satisfies 1≤i≤n and j is an integer that satisfies 1≤j≤n and j≠i. The photo-curable resin is cured in a part or an entirety of the overlap area by irradiating the region Rᵢ with the light.

### BACKGROUND

### Technical Field

The present invention relates to methods for manufacturing stereolithographically fabricated objects.

### Description of the Related Art

Stereolithography is an aspect of the optical fabrication method, and there are two types of stereolithography: a scanning type stereolithography in which a galvanoscanner is used to perform scanning by using laser light, and a projection type stereolithography in which a digital micromirror device (DMD) is used to project light that has been subjected to patterning. In the projection type, light incident on the DMD may be that emitted by a laser light source, or may be that emitted by a lamp typified by a mercury lamp. For example, Non-Patent Literature 1 discloses in FIG. 5 an optical system of the projection type stereolithography that uses laser light having a wavelength λ of 405 nm.

The optical system of Non-Patent Literature 1 collimates laser light and irradiates, with the collimated laser light, a digital micromirror device (DMD). The orientation of each of mirrors constituting the DMD is controlled so that the intensity distribution in the irradiation region of the laser light forms a desired pattern. Thus, when the laser light is reflected by this DMD, the intensity distribution in the irradiation region of the laser light is converted from the substantially uniform distribution to a distribution corresponding to the desired pattern. The laser light subjected to the patterning and having the intensity distribution corresponding to the desired pattern is projected, by means of an objective having a focal length f of 45 mm, on a sample platform with the surface covered by a layer of a photo-curable resin. This makes the layer of the photo-curable resin on the sample platform irradiated with the laser light corresponding to the desired pattern, to form a stereolithographically fabricated object having the desired pattern.

### Non-Patent Literature

Non-patent Literature 1: Michael P. Lee et. al., “Development of a 3D printer using scanning projection stereolithography”, SCIENTIFIC REPORTS, 5, 9875, 2015

Here, irrespective of whether the scanning type or the projection type of stereolithography is used, the minimum dimension of a photo-curable resin to be cured by exposure to light is depending on the minimum dimension of light with which the photo-curable resin is irradiated. Further, the minimum dimension of light with which the photo-curable resin is irradiated is depending on the resolution δ of the irradiation optical system that irradiates the sample platform with light. There are some ways of thinking about the resolution δ: the Rayleigh's resolution, the Abbe's resolution, and the Hopkins' resolution. Using the wavelength λ and the numerical aperture NA, the Rayleigh's resolution is represented by δ=0.61λ/NA, the Abbe's resolution is represented by δ=λ/NA, and the Hopkins' resolution is represented by δ=κλ/NA. Here, κ, included in the formula of the Hopkins' resolution, is a constant that is defined depending on the state of illumination, and the minimum value of κ is 0.58.

Thus, when the stereolithography is used, it is not possible to manufacture a stereolithographically fabricated object including a pattern having a smaller dimension than the resolution δ of the irradiation optical system.

### SUMMARY

One or more embodiments manufacture a stereolithographically fabricated object including a fine pattern, as compared to the resolution of an irradiation optical system.

A method for manufacturing a stereolithographically fabricated object in accordance with one or more embodiments includes first to n-th steps of irradiating, with light, respective n regions R₁ to Rₙ (n is an integer of not less than 2) of a photo-curable resin, wherein part (example of an overlap area) of a region Rᵢ (i is an integer that satisfies 1≤i≤n) coincides with part of a region Rⱼ (j is an integer that satisfies 1≤j≤n and j≠i), and the photo-curable resin is cured in a common region that is part or whole of an overlap (example of the overlap area) formed when the region Rᵢ, which is irradiated with the light in an i-th step, overlaps the region Rⱼ.

According to the method for manufacturing a stereolithographically fabricated object in accordance with one or more embodiments, it is possible to manufacture stereolithographically fabricated object including a fine pattern, as compared to the resolution δ of the irradiation optical system.

### BRIEF DESCRIPTION OF THE DRAWINGS

FIG. 1 is a schematic view illustrating a projection stereolithography device and a scanning stereolithography device, respectively, with which a manufacturing method in accordance with one or more embodiments can be performed.

FIG. 2 is a schematic view illustrating a region R₁ in a first step and a region R₂ in a second step, the first and second steps being included in the manufacturing method in accordance with one or more embodiments and a schematic view illustrating a common region in which a photo-curable resin is cured because the photo-curable resin has been subjected to both the first and second steps.

FIG. 3 is a schematic view illustrating a region R₁ in a first step, a region R₂ in a second step, and a region R₃ in a third step, the first to third steps being included in a first variation of the manufacturing method illustrated in FIG. 2 and a schematic view illustrating a common region in which a photo-curable resin is cured because the photo-curable resin has been subjected to all the first to third steps.

FIG. 4 is a schematic view illustrating a region R₁ in a first step and a region R₂ in a second step, the first and second steps being included in a second variation of the manufacturing method illustrated in FIG. 2 and a schematic view illustrating a common region in which a photo-curable resin is cured because the photo-curable resin has been subjected to both the first and second steps.

FIG. 5 is a schematic view illustrating a variation of the stereolithography device illustrated in (a) of FIG. 1.

### DESCRIPTION OF THE EMBODIMENTS

### [Stereolithography Devices]

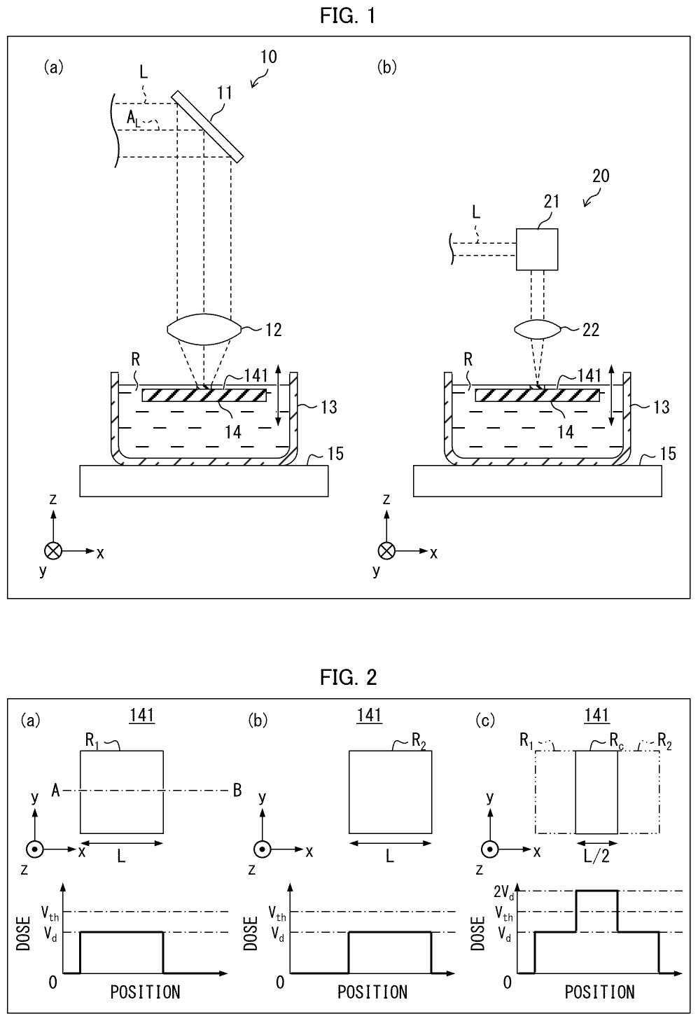

Before describing a method of manufacturing a stereolithographically fabricated object in accordance with one or more embodiments, the following will describe, with reference to FIG. 1, the configurations of stereolithography devices 10 and 20 with which the present manufacturing method can be suitably performed. (a) and (b) of FIG. 1 are schematic views of the stereolithography devices 10 and 20, respectively.

### <Projection Type>

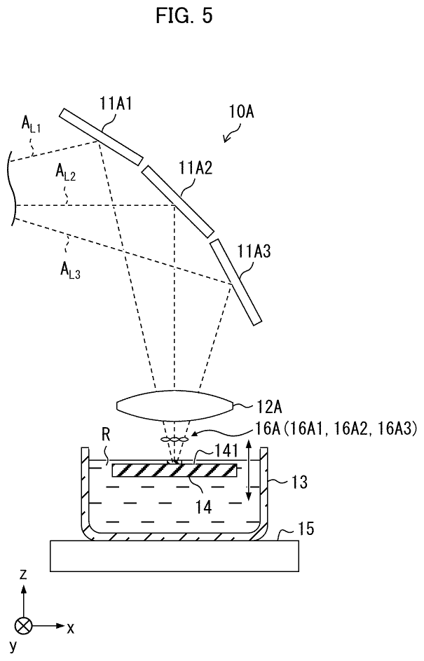

The stereolithography device 10 includes a digital micromirror device (DMD) 11, a lens 12, a container 13, a sample platform 14, and a stage 15 (see (a) of FIG. 1). Although not illustrated in (a) of FIG. 1, the stereolithography device 10 also includes a laser device that produces light L to which a photo-curable resin R is exposed. Similarly to the stereolithography device depicted in FIG. 5 of Non-Patent Literature 1, the stereolithography device 10 is an example of projection stereolithography devices.

### (Irradiation Optical System)

According to one or more embodiments, the laser device includes a semiconductor module configured to produce light L having a wavelength λ of 405 nm. The light L emitted from the laser device undergoes conversion from diverging light to collimated light, which is illustrated in (a) of FIG. 1, by means of a collimating optical system including a lens. Here, (a) of FIG. 1 depicts the central axis of a bundle of rays of light L as an optical axis A_{L}. The optical axis A_{L} corresponds to an optical path through which a chief ray of the light L travels.

In (a) of FIG. 1, a vertically upward direction orthogonal to the surface of a liquid photo-curable resin R (i.e., the horizontal plane) is defined as a positive z-axial direction, a propagation direction of light L before being incident on the DMD 11 is defined as a positive x-axis direction, and a direction constituting the right-handed orthogonal coordinate system with the positive x-axial direction and the positive z-axial direction is defined as a positive y-axial direction.

The DMD 11 includes a plurality of mirrors arranged in a matrix pattern. The orientation of each mirror is controlled by a computer, and each mirror is controlled to face in either a first direction or a second direction. When a mirror faces in the first direction, light L reflects off the mirror and propagates in the negative z-axial direction. This state is referred to as the ON state. When a mirror faces in the second direction, light L reflects off the mirror and propagates in another direction different from the negative z-axial direction. This state is referred to as the OFF state. Thus, by selecting at least one of the mirrors arranged in the matrix pattern and by changing the state of the selected one or ones to the ON state, the DMD 11 can form a pattern of the intensity distribution in the irradiation region of reflected light L propagating in the negative z-axial direction.

The light L subjected to the patterning with the DMD 11 so as to have an intensity distribution of a desired pattern is then projected, by means of the lens 12, on a main face 141 of the sample platform 14 located below a layer of the photo-curable resin R. The lens 12 functions as an objective. The sample platform 14 will be described later.

In the stereolithography device 10, the laser device, the collimating optical system, the DMD 11, and the lens 12 constitute an irradiation optical system configured to irradiate the photo-curable resin R with light L. It is preferable that the irradiation optical system be adjusted to form the finest possible pattern of light L projected on the main face 141, as described later. That is, it is preferable that the irradiation optical system be adjusted so as to achieve the highest possible resolution.

It should be noted that there are some ways of thinking about the resolution δ of the irradiation optical system: the Rayleigh's resolution, the Abbe's resolution, and the Hopkins' resolution. When the wavelength λ of 405 nm and the numerical aperture NA of 1 are employed, the Rayleigh's resolution and the Abbe's resolution are 247 nm and 405 nm, respectively. The Hopkins' resolution is 235 nm when κ=0.58, which is the minimum value.

### (Photo-Curable Resin Holding System)

Below the DMD 11, the container 13, the sample platform 14, and the stage 15 are disposed.

The stage 15 is a three-axis stage that is capable of moving the table in a translational manner in the x-, y-, and z-axial directions. The stage 15 has a resolution on the order of nanometers, to precisely control the positions of the container 13 and the sample platform 14, as described later. Examples of the xyz stage having a resolution on the order of nanometers include an xyz stage that is provided with a piezoactuator for use in driving of the table in each axial direction. Such an xyz stage may have a resolution of about 5 nm, for example. It should be noted that (a) of FIG. 1 depicts the stage 15 by showing only the table thereof. It should be noted that the stage 15 is controlled by a computer. To the table of the stage 15, a z-axis stage, described later, is secured.

On the table of the stage 15, the container 13 is situated. Inside the container 13, the sample platform 14 and a photo-curable resin R are provided.

The sample platform 14 is connected to the z-axis stage outside the container 13. The z-axis stage is configured to move translationally in the z-axial direction. As described above, the z-axis stage is secured to the table of the stage 15. Thus, when the table of the stage 15 is moved, the container 13, the z-axis stage, and the sample platform 14 are moved in synchronization (moved in an integrated manner). That is, the relative position of the sample platform 14 with respect to the container 13 in the xy plane is fixed. It should be noted that the z-axis stage is controlled by a computer.

A liquid photo-curable resin R is cured into a solid when being irradiated with light L of a dose that exceeds a threshold. The photo-curable resin R may be selected, depending on the purpose of use, from commercially available photo-curable resins for use in optical fabrication.

The stereolithography device 10 uses the free surface technique in which the free surface of a photo-curable resin R is irradiated with light L in a vertically downward direction. Thus, the position of the sample platform 14 on the z-axis is controlled with the z-axis stage so that the main face 141, which is one of a pair of the main faces and is located on the positive side of the z-axis, is located slightly lower than the free surface. This forms, on the main face 141, a layer of the photo-curable resin R having a predetermined thickness (e.g., not less than 2 μm and not more than 5 μm).

In the stereolithography device 10, the container 13, the sample platform 14, the stage 15, and the z-axis stage constitute a photo-curable resin holding system configured to hold the photo-curable resin R.

As described above, light L subjected to the patterning with the DMD 11 is projected, by means of the lens 12, on the main face 141 that is located below the layer of the photo-curable resin R. Thus, the pattern formed with the DMD 11 by means of the mirrors in the ON state is transferred on the layer of the photo-curable resin R on the main face 141. This creates a stereolithographically fabricated object that has a desired pattern, on the main face 141.

### <Scanning Type>

The stereolithography device 20 includes a galvanoscanner 21, a lens 22, a container 13, a sample platform 14, and a stage 15 (see (b) of FIG. 1). The stereolithography device 20 is an example of scanning stereolithography devices.

The container 13, the sample platform 14, and the stage 15 are identical to those included in the stereolithography device 10.

Although not illustrated in (b) of FIG. 1, the stereolithography device 20 also includes a laser device that produces light L to which a photo-curable resin R is exposed. This laser device is identical to that included in the stereolithography device 10.

Collimated light L emitted from the laser device enters the galvanoscanner 21. The galvanoscanner 21 includes two mirrors, and two motors each configured to control the orientation of a corresponding one of the mirrors. The galvanoscanner 21 is controlled by a computer. By adjusting the orientations of the two mirrors, the galvanoscanner 21 can perform scanning, using light L with which a main face 141 is irradiated.

In the stereolithography device 20, the laser device, the collimating optical system, and the galvanoscanner 21 constitute an irradiation optical system configured to irradiate the photo-curable resin R with light L.

The lens 22 functions as an objective, similarly to the lens 12.

### [Method for Manufacturing Stereolithographically Fabricated Object]

The following will describe a method for manufacturing a stereolithographically fabricated object in accordance with one or more embodiments, with reference to FIG. 2. (a) and (b) of FIG. 2 are schematic views illustrating a region R₁ in a first step and a region R₂ in a second step, respectively, the first and second steps being included in the present manufacturing method. (c) of FIG. 2 is a schematic view illustrating a common region R_{c} in which a photo-curable resin R is cured because the photo-curable resin R has been subjected to both the first and second steps. Here, the upper diagrams of (a) to (c) of FIG. 2 are plan views of the regions when the main face 141 of the sample platform 14 included in the stereolithography device 10 is viewed from above. The lower diagrams of (a) to (c) of FIG. 2 are graphs each showing the dose on the line segment AB, illustrated in (a) of FIG. 2. It should be noted that a layer of the photo-curable resin R is formed on the main face 141.

<Case in which Projection Stereolithography Device is Used>

Here, the following will describe a case in which the projection stereolithography device 10 is used in performing the present manufacturing method. Light L has a wavelength λ of 405 nm, and the lens 12 has a numerical aperture NA of 1. In this case, the Rayleigh's resolution and the Abbe's resolution are 247 nm and 405 nm, respectively. The Hopkins' resolution is 235 nm when κ=0.58, which is the minimum value.

The present manufacturing method includes a first step illustrated in (a) of FIG. 2 and a second step illustrated in (b) of FIG. 2. That is, the present manufacturing method is an example of a case of n=2 in the manufacturing method in accordance with one or more embodiments. However, according to the manufacturing method in accordance with one or more embodiments, n is not limited to 2, and n only needs to be an integer of not less than 2.

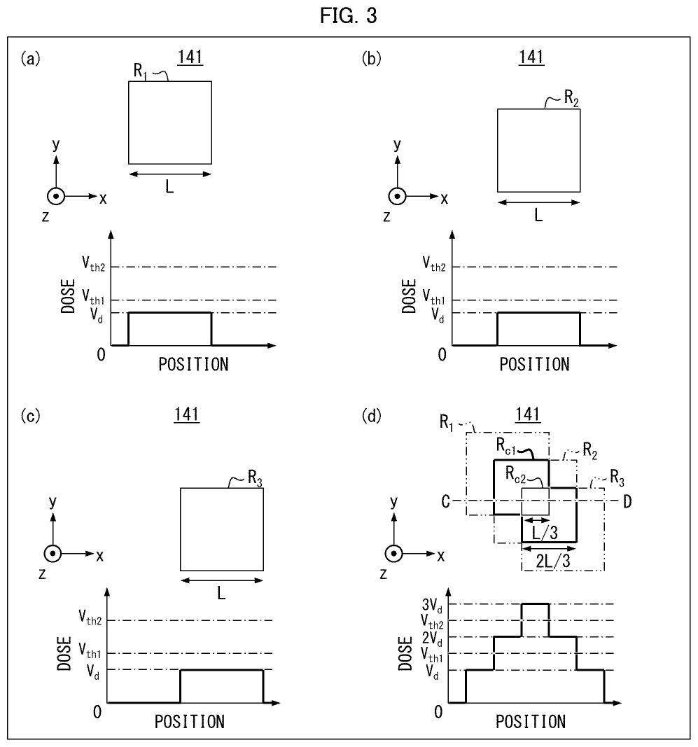

The first step is a step of irradiating, with light L, the region R₁ of a photo-curable resin R on the main face 141. According to one or more embodiments, the region R₁ is a square having a side length L of 405 nm. For example, a first variation, which will be described later with reference to FIG. 3, employs n=3.

The second step is a step of irradiating, with light L, the region R₂ of the photo-curable resin R on the main face 141. In one or more embodiments, the region R₂ is a square having a side length L of 405 nm, similarly to the region R₁.

The present manufacturing method uses the stereolithography device 10 that includes a single DMD 11, so that the first step and the second step are performed in turn at different timings. In addition, in one or more embodiments, the dose of light L in the first step and that in the second step are the same, and are dose V_{d}.

The region R₂ is obtained by translationally moving the region R₁ by L/2 in the positive x-axial direction. Thus, the region R₁ and the region R₂ overlap. In the present manufacturing method, since n=2, the whole overlap between the region R₁ and the region R₂ forms a common region R_{c}. The common region R_{c} is a rectangle having a length in the x-axial direction of 202.5 nm, which corresponds to L/2, and a length in the y-axial direction of 405 nm.

The dose V_{d} of light L in the first and second steps may be set to any desired value in accordance with the intensity of light L and the exposure time. In the present manufacturing method, the photo-curable resin R in the common region R_{c}, described later, of the photo-curable resin R in the regions R₁ and R₂ is cured, and the photo-curable resin R is not cured outside the common region R_{c}. Thus, when a threshold at which the photo-curable resin R is cured is assumed to be threshold Vₜₕ, the dose V_{d} may be set to satisfy both Vₜₕ<2V_{d} and V_{d}<Vₜₕ, that is, Vₜₕ/2<V_{d}<Vₜₕ. In the present manufacturing method, the dose V_{d} of light L in the first step is set so that V_{d}=2Vₜₕ/3 (see (c) of FIG. 2).

Dose 2V_{d} in the common region R_{c} is thus 2V_{d}=4Vₜₕ/3. On the other hand, the dose V_{d} in the remaining region in the regions R₁ and R₂, which is other than the common region R_{c}, is thus V_{d}=2Vₜₕ/3. Thus, only the photo-curable resin R in the common region R_{c} is cured.

In this way, in the present manufacturing method, it is possible to manufacture a stereolithographically fabricated object including a fine pattern, as compared to the resolution δ (e.g., 235 nm) of the irradiation optical system.

When the stereolithography device 10 illustrated in (a) of FIG. 1 is used in performing the present manufacturing method, both the regions R₁ and R₂ are formed by means of the single DMD 11. Thus, the first step and the second step are performed in turn at different timings. Further, the positions of the regions R₁ and R₂ of the photo-curable resin R (see FIG. 2) may be determined in accordance with the arrangement of part of the irradiation optical system (e.g., at least one of the DMD 11 and the lens 12), which is an optical system configured to irradiate the photo-curable resin R with light L. Further, the positions of the regions R₁ and R₂ of the photo-curable resin R may be determined in accordance with both the position of the sample platform 14 irradiated with light L and the position of the container 13. In this case, the sample platform 14 and the container 13 may be configured to be moved in synchronization (moved in an integrated manner). Further, the present manufacturing method is more effective in a case in which the minimum dimension (L/2 in (a) of FIG. 2) of the pattern included in the common region R_{c} is not more than the resolution δ (e.g., 235 nm) of the irradiation optical system, which is the optical system configured to irradiate the photo-curable resin R with light L. That is, the present manufacturing method is more effective in a case in which, in the photo-curable resin R, an amount of translational movement from the region R₁ to the region R₂ is not more than the resolution δ.

It should be noted that, in the manufacturing method in accordance with one or more embodiments, n is not limited to 2, and n of an integer of not less than 2 may be employed. In this case, the manufacturing method in accordance with one or more embodiments includes first to n-th steps of irradiating, with light, respective n regions R₁ to Rₙ of the photo-curable resin R. Part of a region Rᵢ (i is an integer that satisfies 1≤i≤n) coincides with part of a region Rⱼ (j is an integer that satisfies 1≤j≤n and j≠i). With this configuration, the manufacturing method in accordance with one or more embodiments causes the photo-curable resin R to be cured in a common region that is part or whole of the overlap formed when the region Rᵢ irradiated with light L in an i-th step overlaps the region Rⱼ. Here, the area of the part of the region Rᵢ may be greater than 20% and less than 100% with respect to the whole area of the region Rᵢ. Further, the area of the part of the region Rⱼ may be greater than 20% and less than 100% with respect to the whole area of the region Rⱼ.

### <First Variation>

The following will describe a first variation of the manufacturing method illustrated in FIG. 2, with reference to FIG. 3. (a) to (c) of FIG. 3 are schematic views illustrating a region R₁ in a first step, a region R₂ in a second step, and a region R₃ in a third step, respectively, the first to third steps being included in the manufacturing method in accordance with the first variation. (d) of FIG. 3 is a schematic view illustrating a common region R_{c} in which a photo-curable resin R is cured because the photo-curable resin R has been subjected to all the first to third steps. Similarly to the case depicted in FIG. 2, the upper diagrams of (a) to (d) of FIG. 3 are plan views of the regions when the main face 141 of the sample platform 14 included in the stereolithography device 20 is viewed from above. The lower diagrams of (a) to (d) of FIG. 3 are graphs each showing the dose on the line segment CD, illustrated in (d) of FIG. 3.

The first variation is an example of a case of n=3 in the manufacturing method in accordance with one or more embodiments. Thus, as illustrated in (a), (b), and (c) of FIG. 3, the first variation includes the first step, the second step, and the third step.

In i-th steps (i is an integer that satisfies 1≤i≤3), respective regions Rᵢ are irradiated with light L. Similarly to the case of the manufacturing method illustrated in FIG. 2, the region Rᵢ is a square having a side length L of 405 nm.

Regions Rᵢ₊₁ are obtained by translationally moving the regions Rᵢ by L/3 in both the positive x-axial direction and the negative y-axial direction. Thus, the regions Rᵢ overlap each other. Hereinbelow, an overlap between at least two of the regions R₁ to R₃ is referred to as a first common region R_{c1}, and an overlap between all of the regions R₁ to R₃ is referred to as a second common region R_{c2}.

The first common region R_{c1} is the whole overlap formed when the region Rᵢ irradiated with light L in the corresponding i-th step overlaps the region Rⱼ (j is an integer that satisfies 1≤j≤n and j≠i). The first common region R_{c1} has a shape of overlapping two squares each having a side length of 270 nm.

The second common region R_{c2} is part of the entire overlap formed when the region Rᵢ irradiated with light L in the corresponding i-th step overlaps the region Rⱼ. In the first common region R_{c1}, the width of the narrowest portion is 191 nm. Further, the second common region R_{c2} is a square having a side length of 135 nm.

In the first variation, the dose of light L is the same in every i-th step, and is dose V_{d}.

A threshold at which the photo-curable resin R in the first common region R_{c1} is cured is assumed to be threshold Vₜₕ₁. In this case, the dose V_{d} only needs to be set to satisfy both Vₜₕ₁<2V_{d} and V_{d}<Vₜₕ₁, that is, Vₜₕ₁/2<V_{d}<Vₜₕ₁.

Further, a threshold at which the photo-curable resin R in the second common region R_{c2} is cured is assumed to be threshold Vₜₕ₂. In this case, the dose V_{d} only needs to be set to satisfy both Vₜₕ₂<3V_{d} and 2V_{d}<Vₜₕ₂, that is, Vₜₕ₂/3<V_{d}<Vₜₕ₂/2.

According to this first variation, it is possible to selectively cure the photo-curable resin R in the first common region R_{c1} or the second common region R_{c2} by controlling the dose V_{d} in each i-th step. Thus, according to the first variation, it is possible to manufacture a stereolithographically fabricated object including a fine pattern, as compared to the resolution δ (e.g., 235 nm) of the irradiation optical system.

<Second Variation: Case in which Scanning Stereolithography Device is Used>

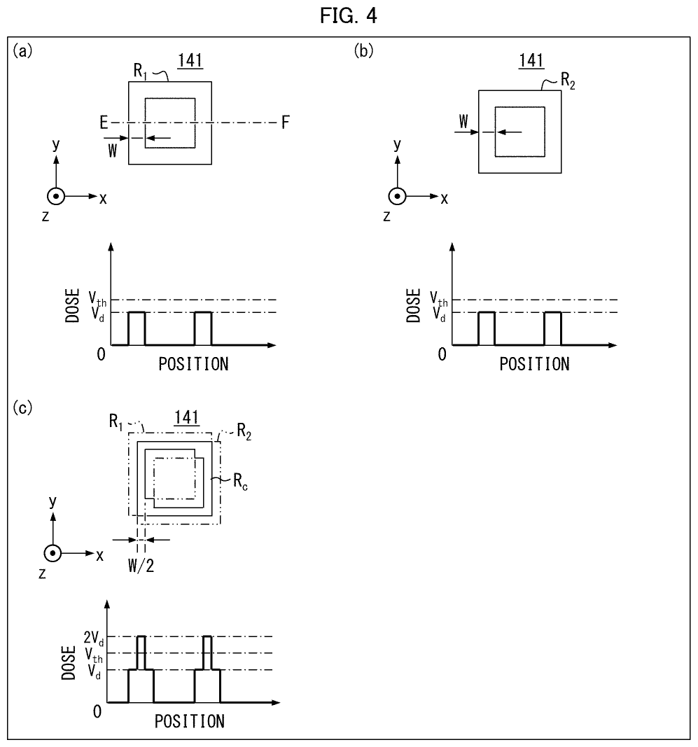

The following will describe a second variation of the manufacturing method illustrated in FIG. 2, with reference to FIG. 4. (a) and (b) of FIG. 4 are schematic views illustrating a region R₁ in a first step and a region R₂ in a second step, respectively, the first and second steps being included in the manufacturing method in accordance with the second variation. (c) of FIG. 4 is a schematic view illustrating a common region R_{c} in which a photo-curable resin R is cured because the photo-curable resin R has been subjected to both the first and second steps. Here, the upper diagrams of (a) to (c) of FIG. 4 are plan views of the regions when the main face 141 of the sample platform 14 included in the stereolithography device 20 is viewed from above. The lower diagrams of (a) to (c) of the figure are graphs each showing the dose on the line segment EF, illustrated in (a) of FIG. 4. It should be noted that a layer of the photo-curable resin R is formed on the main face 141.

The following will describe a case in which a scanning stereolithography device 20 is used, in the second variation, in performing the present manufacturing method, instead of the projection stereolithography device 10. Light L has a wavelength λ of 405 nm, and the lens 12 has a numerical aperture NA of 1. In this case, the Rayleigh's resolution and the Abbe's resolution are 247 nm and 405 nm, respectively. The Hopkins' resolution is 235 nm when κ=0.58, which is the minimum value.

The second variation includes: the first step in which the photo-curable resin R in the region R₁ is irradiated with light; and the second step in which the photo-curable resin R in the region R₂ is irradiated with light. According to the second variation, the first step and the second step are performed in turn at different timings because the scanning stereolithography device 20 is used.

In the second variation, a region Rᵢ (i is an integer that satisfies 1≤i≤n) overlaps a region Rⱼ (j is an integer that satisfies 1≤j≤n and j≠i). Specifically, the region R₁ and the region R₂ overlap. With this configuration, in the second variation, the photo-curable resin R in a common region R_{c} that is the overlap between the region R₁ and the region R₂ is cured. This configuration in the second variation is identical to that in the manufacturing method illustrated in FIG. 2.

A difference between the second variation and the manufacturing method illustrated in FIG. 2 is how the photo-curable resin R is irradiated with light L. In the second variation, the galvanoscanner 21 illustrated in (b) of FIG. 1 is used in scanning in which light L in the form of laser light is used, to transfer the patterns of the regions R₁ and R₂ on the photo-curable resin R.

In the second variation, each of the regions R₁ and R₂ is a ring-shaped region having a square outer periphery (see (a) and (b) of FIG. 4). Here, each of the regions R₁ and R₂ has an outer peripheral side length of 2.46 μm, and a width W of the ring portion of 405 nm. The region R₂ is obtained by translationally moving the region R₁ by W/2 in both the positive x-axial direction and the negative y-axial direction.

Performing both the first and second steps forms the common region R_{c} that is the whole overlap between the regions R₁ and R₂. Similarly to the regions R₁ and R₂, the common region R_{c} is a ring-shaped region having a square outer periphery. The outer peripheral side length of the common region R_{c} is shorter than those of the regions R₁ and R₂ by W/2, and most part of the ring portion has a width of 202.5 nm, which corresponds to W/2.

In this way, in the second variation, a stereolithographically fabricated object including a fine pattern, as compared to the resolution δ (e.g., 235 nm) of the irradiation optical system, can also be manufactured by the use of the scanning stereolithography device 20.

### [Variation of Stereolithography Device]

The following will describe a stereolithography device 10A, which is a variation of the stereolithography device 10 illustrated in (a) of FIG. 1, with reference to FIG. 5. FIG. 5 is a schematic view illustrating the stereolithography device 10A.

The stereolithography device 10 includes the DMD 11 as a means for patterning light L. Thus, in the manufacturing method illustrated in FIG. 2, the DMD 11 is controlled to irradiate, with light L, the regions R₁ and R₂ in turn in corresponding one of the first and second steps. Thus, the manufacturing method illustrated in FIG. 2 (case of n=2) employs a configuration in which the first and second steps are performed in turn at different timings. This also applies to the manufacturing method illustrated in FIG. 3 (case of n=3).

In contrast, the stereolithography device 10A employs n=3, and includes, as the means for patterning light L, three DMDs 11A1, 11A2, and 11A3, the number of which is equal to n (see FIG. 5). Each DMD 11Ai is an example of an i-th digital micromirror device Dᵢ. Further, to cause separate rays of light to be incident on the respective DMDs 11Ai (i is an integer that satisfies 1≤i≤3), the stereolithography device 10A includes three laser devices (not illustrated in FIG. 5), the number of which is equal to n. Here, FIG. depicts optical axes A_{Li}, each of which is the central axis of a corresponding bundle of rays, and each optical axis A_{Li} represents light that corresponds to the DMD 11Ai.

Thus, each DMD 11Ai reflects light that has been transmitted along the optical axis A_{Li}, forming the pattern of the corresponding region Rᵢ. In this way, the stereolithography device 10A includes the irradiation optical systems the number of which is set to be equal to n (3, in the present variation). This enables the stereolithography device 10A to perform an i-th step at a timing which is identical to a timing of another i-th step.

The light that has been subjected to the patterning of the intensity distribution to form a desired pattern with the corresponding DMD 11Ai is projected, by means of a lens 12A, on a main face 141 of a sample platform 14 located below a layer of a photo-curable resin R. The lens 12A functions as an objective, similarly to the lens 12 illustrated in (a) of FIG. 1.

Further, in the stereolithography device 10A, on an optical path extending from each DMD 11Ai to the photo-curable resin R, a lens 16i corresponding to the DMD 11Ai is disposed. The lenses 16i are examples of lenses Mᵢ. Here, in the present variation, each lens 16i is disposed on the corresponding optical path in a section between the lens 12A and the photo-curable resin R. Here, as the lenses 16i, used is a microlens array 16 in which appropriately arranged multiple microlenses are integrated.

Among the DMDs 11Ai, the DMD 11A2 is arranged to face in the same direction as that the DMD 11 of the stereolithography device 10 faces. The DMD 11A2 causes the layer of the photo-curable resin R in the region R₂ to be irradiated with light, the layer being formed on the main face 141 of the sample platform 14 (see (b) of FIG. 3).

The orientation of the DMD 11A1 is adjusted so that the photo-curable resin R in the region R₁ (see (a) of FIG. 3) is irradiated with light. Further, the orientation of the DMD 11A3 is adjusted so that the photo-curable resin R in the region R₃ (see (c) of FIG. 3) is irradiated with light.

Using the stereolithography device 10A thus configured forms the regions Rᵢ by means of the respective DMDs 11Ai (which is an example of the i-th digital micromirror devices Dᵢ). In this case, it is preferable that an i-th step be performed at a timing which is identical to a timing of another i-th step.

The stereolithography device 10A can be obtained by modifying the stereolithography device 10 illustrated in (a) of FIG. 1 so as to change the number of the irradiation optical systems to a number equal to n. Similarly, by modifying the stereolithography device 20 illustrated in (b) of FIG. 1 so as to change the number of the irradiation optical systems to a number equal to n, it is possible to perform an i-th step at a timing which is identical to a timing of another i-th step even when the scanning stereolithography device is used in performing the manufacturing method in accordance with one or more embodiments.

Aspects of one or more embodiments can also be expressed as follows:

A method for manufacturing a stereolithographically fabricated object in accordance with an Aspect 1 of one or more embodiments, includes first to n-th steps of irradiating, with light, respective n regions R₁ to Rₙ (n is an integer of not less than 2) of a photo-curable resin, wherein part of a region Rᵢ (i is an integer that satisfies 1≤i≤n) coincides with part of a region Rⱼ (j is an integer that satisfies 1≤j≤n and j≠i), and the photo-curable resin is cured in a common region that is part or whole of an overlap formed when the region Rᵢ, which is irradiated with the light in an i-th step, overlaps the region Rⱼ.

With this configuration, since the common region that is part or whole of the overlap between the region Rᵢ and the region Rⱼ is cured, it is possible to manufacture a stereolithographically fabricated object including a fine pattern, as compared to the resolution of the irradiation optical system.

Further, a method for manufacturing a stereolithographically fabricated object in accordance with an Aspect 2 of one or more embodiments, employs, in addition to the configuration of the method of manufacturing a stereolithographically fabricated object in accordance with the Aspect 1, a configuration in which the region Rᵢ is formed by a corresponding i-th digital micromirror device Dᵢ.

With this configuration, it is possible to freely determine the timing at which the i-th step is performed.

A method for manufacturing a stereolithographically fabricated object in accordance with an Aspect 3 of one or more embodiments, employs, in addition to the configuration of the method of manufacturing a stereolithographically fabricated object in accordance with the Aspect 2, a configuration in which, on an optical path extending from each digital micromirror device Dᵢ to the photo-curable resin, a lens Mᵢ corresponding to the digital micromirror device Dᵢ is disposed.

With this configuration, it is possible to reliably form an image of the region Rᵢ at a predetermined position when the plurality of i-th digital micromirror devices Dᵢ are used to form images of the respective regions Rᵢ.

A method for manufacturing a stereolithographically fabricated object in accordance with an Aspect 4 of one or more embodiments, employs, in addition to the configuration of the method of manufacturing a stereolithographically fabricated object in accordance with the Aspect 2 or 3, a configuration in which the i-th step is performed at a timing which is identical to a timing of another i-th step.

With this configuration, since the regions Rᵢ are exposed to light at once, it is possible to prevent the regions Rᵢ from being displaced owing to a time-dependent factor. It is also possible to shorten the time required for performing stereolithography.

A method for manufacturing a stereolithographically fabricated object in accordance with an Aspect 5 of one or more embodiments, employs, in addition to the configuration of the method of manufacturing a stereolithographically fabricated object in accordance with the Aspect 1, a configuration in which the region Rᵢ is formed by means of a single digital micromirror device, and the i-th step is performed at a timing which is different from a timing of another i-th step.

With this configuration, it is possible to form the region Rᵢ without using a plurality of digital micromirror devices. Thus, it is possible to perform the present manufacturing method by using such a simple irradiation optical system.

A method for manufacturing a stereolithographically fabricated object in accordance with an Aspect 6 of one or more embodiments, employs, in addition to the configuration of the method of manufacturing a stereolithographically fabricated object in accordance with the Aspect 5, a configuration in which a position of the region Rᵢ of the photo-curable resin is determined in accordance with an arrangement of part of an irradiation optical system that is an optical system configured to irradiate the photo-curable resin with the light.

With this configuration, it is possible to control the position of the region Rᵢ by controlling the position of the part of the irradiation optical system. Thus, it is possible to perform the present manufacturing method by using the irradiation optical system of the existing projection stereolithography.

A method for manufacturing a stereolithographically fabricated object in accordance with an Aspect 7 of one or more embodiments, employs, in addition to the configuration of the method of manufacturing a stereolithographically fabricated object in accordance with the Aspect 5 or 6, a configuration in which a position of the region Rᵢ of the photo-curable resin is determined in accordance with both a position of a sample platform irradiated with the light and a position of a container configured to hold the photo-curable resin, and the sample platform and the container are moved in synchronization.

With this configuration, it is possible to control the position of the region Rᵢ by controlling the positions of the sample platform and the container, which are move in synchronization (moved in an integrated manner). Thus, it is possible to perform the present manufacturing method by using the irradiation optical system of the existing projection stereolithography.

A method for manufacturing a stereolithographically fabricated object in accordance with an Aspect 8 of one or more embodiments, employs, in addition to the configuration of the method of manufacturing a stereolithographically fabricated object in accordance with any one of the Aspects 1 to 7, a configuration in which a minimum dimension of a pattern included in the common region is less than a resolution of an irradiation optical system that is an optical system configured to irradiate the photo-curable resin with light.

Therefore, the method for manufacturing a stereolithographically fabricated object in accordance with one or more embodiments is more effective in a case in which the minimum dimension of the pattern included in the common region is less than the resolution of the irradiation optical system, which is the optical system configured to irradiate the photo-curable resin with light.

### SUPPLEMENTARY NOTES

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

10, 10A, 20 Stereolithography devices
11, 11A1 to 11A3 Digital micromirror devices (DMDs)
12, 12A, 22 Lenses
13 Container
14 Sample platform
141 Main face
15 Stage
16 Microlens array
161 to 163 lenses
R Photo-curable resin
21 Galvanoscanner
R₁ to Rₙ, Rᵢ Regions
R_{c} Common region
R_{c1}, R_{c2} First common region, second common region (examples of common region)

1. A method for manufacturing a stereolithographically fabricated object, comprising:
separately irradiating, with light, respective n regions R₁ to Rₙ of a photo-curable resin, where n is an integer of not less than 2, wherein
an overlap area of the region Rᵢ overlaps a part of the region Rⱼ, where i is an integer that satisfies 1≤i≤n and j is an integer that satisfies 1≤j≤n and j≠i, and
the photo-curable resin is cured in a part or an entirety of the overlap area by irradiating the region Rᵢ with the light.

2. The method according to claim 1, wherein the region Rᵢ is formed by a corresponding i-th digital micromirror device.

3. The method according to claim 2, wherein, on an optical path from the corresponding i-th digital micromirror device to the photo-curable resin, a lens corresponding to the corresponding i-th digital micromirror device is disposed.

4. The method according to claim 2, wherein the respective n regions R₁ to Rₙ are irradiated simultaneously.

5. The method according to claim 1, wherein
the region Rᵢ is formed by a single digital micromirror device, and
the respective n regions R₁ to Rₙ are irradiated at different times.

6. The method according to claim 5, wherein a position of the region Rᵢ of the photo-curable resin is determined in accordance with an arrangement of a part of an irradiation optical system that irradiates the photo-curable resin with the light.

7. The method according to claim 5, wherein
a position of the region Rᵢ of the photo-curable resin is determined in accordance with both a position of a sample platform irradiated with the light and a position of a container that holds the photo-curable resin, and
the sample platform and the container are moved in synchronization.

8. The method according to claim 1, wherein a minimum dimension of a pattern included in the part or the entirety of the overlap area is less than a resolution of an irradiation optical system that irradiates the photo-curable resin with light.
